(19) United States
(12) Patent Application Publication
(10) Pub. No.: US 2025/0260257 A1
(43) Pub. Date: Aug. 14, 2025

(54) ELECTRICITY SUPPLY SYSTEM, CONTROL DEVICE, AND NON-TRANSITORY STORAGE MEDIUM

(71) Applicant: TOYOTA JIDOSHA KABUSHIKI KAISHA, Toyota-shi (JP)

(72) Inventor: Yukinori MURAKAMI, Toyota-shi (JP)

(21) Appl. No.: 19/036,117

(22) Filed: Jan. 24, 2025

(30) Foreign Application Priority Data
Feb. 8, 2024 (JP) 2024-017779

(51) Int. Cl. H02J 7/35; B60R 16/033; H02J 7/00

(52) U.S. Cl. CPC H02J 7/35; B60R 16/033; H02J 7/0013; H02J 7/0047; H02J 2310/48

(57) ABSTRACT

An electricity supply system includes a solar panel, a solar converter, a group of auxiliaries, a battery, a bidirectional converter, and a control device. The control device is configured to control the bidirectional converter. The control device is configured to execute specific control during a period when a fluctuation condition is met. The fluctuation condition is a condition showing that fluctuation in at least either electricity output by the solar panel or electricity consumed by the group of auxiliaries is large. The specific control is control configured to control one or more selected from the solar converter, the group of auxiliaries, and the bidirectional converter such that a magnitude relationship between the electricity output by the solar converter and the electricity consumed by the group of auxiliaries remains the same.

### CROSS-REFERENCE TO RELATED APPLICATION

This application claims priority to Japanese Patent Application No. 2024-017779 filed on Feb. 8, 2024, incorporated herein by reference in its entirety.

### BACKGROUND

### 1. Technical Field

The present disclosure relates to an electricity supply system, a control device, and a non-transitory storage medium.

### 2. Description of Related Art

The vehicle disclosed in Japanese Unexamined Patent Application Publication No. 2021-083248 (JP 2021-083248 A) includes a solar panel, auxiliaries, a driving battery, and a control device. The auxiliaries are supplied with electricity generated by the solar panel. The driving battery is a high-voltage battery that supplies electricity to a driving source of the vehicle. The driving battery is located on a branch path branching off from an electricity supply path leading from the solar panel to the auxiliaries. When the amount of electricity generated by the solar panel is large, the control device switches the electricity supply path such that the electricity generated by the solar panel is supplied not only to the auxiliaries but also to the driving battery.

### SUMMARY

In a technology like JP 2021-083248 A, a bidirectional converter that can switch the direction of electricity supply is sometimes employed at a point short of the driving battery in the branch path. This bidirectional converter is sometimes controlled as follows according to which of the electricity generated by the solar panel and the electricity consumed by the auxiliaries is higher or lower. When the electricity generated by the solar panel is excessive relative to the electricity consumed by the auxiliaries, the electricity generated by the solar panel is supplied to the driving battery. On the other hand, when the electricity generated by the solar panel is insufficient relative to the electricity consumed by the auxiliaries, the electricity is supplied from the driving battery to the auxiliaries. In the case where such a manner of control is adopted, the magnitude relationship between the electricity generated by the solar panel and the electricity consumed by the auxiliaries can switch frequently as the electricity generated or the electricity consumed fluctuates. In this case, the direction of electricity supply by the bidirectional converter is frequently switched, which places burden on the bidirectional converter.

A first aspect of this disclosure is an electricity supply system. The electricity supply system includes: a solar panel; a solar converter that is able to convert electricity output by the solar panel and output the electricity; a group of auxiliaries that is supplied with the electricity output by the solar converter; a battery; a bidirectional converter that is able to convert a voltage of electricity output by the battery and supply the electricity to the group of auxiliaries, as well as to convert a voltage of the electricity output by the solar converter and supply the electricity to the battery; and a control device configured to control the solar converter, the group of auxiliaries, and the bidirectional converter. As switching control, the control device is configured to, when a first condition is met, control the bidirectional converter such that the electricity is directed from the solar converter to the battery, and when a second condition is met, control the bidirectional converter such that the electricity is directed from the battery to the group of auxiliaries. The first condition is a condition that the electricity output by the solar converter is higher than electricity consumed by the group of auxiliaries. The second condition is a condition that the electricity output by the solar converter is lower than the electricity consumed by the group of auxiliaries. The control device is configured to execute specific control during a period when a fluctuation condition is met. The fluctuation condition is a condition that is set beforehand as a condition showing that fluctuation in at least either the electricity output by the solar panel or the electricity consumed by the group of auxiliaries is large. The specific control is control configured to control one or more selected from the solar converter, the group of auxiliaries, and the bidirectional converter such that a magnitude relationship between the electricity output by the solar converter and the electricity consumed by the group of auxiliaries remains the same.

In the electricity supply system according to the first aspect of this disclosure, the fluctuation condition may be a condition that a difference between a maximum value and a minimum value of the electricity consumed by the group of auxiliaries during a unit period is equal to or larger than a specified value that is set beforehand.

The electricity supply system according to the first aspect of this disclosure may include a second battery to and from which the electricity output by the solar converter is chargeable and dischargeable, and a temperature sensor configured to detect a temperature of the second battery. The battery may be a first battery. The control device may be configured to execute the specific control based on a requisite condition that the temperature of the second battery is outside a predetermined range that is set beforehand.

In the electricity supply system according to the first aspect of this disclosure, the control device may be configured to, when the first condition is met at a predetermined timing, control the bidirectional converter in the specific control such that the electricity supplied from the bidirectional converter to the battery becomes lower than that in a state where the fluctuation condition is not met. The predetermined timing may be a timing when the state where the fluctuation condition is not met has switched to a state where the fluctuation condition is met.

In the electricity supply system according to the first aspect of this disclosure, the control device may be configured to, when the first condition is met at a predetermined timing, control the group of auxiliaries in the specific control such that the electricity consumed by the group of auxiliaries becomes lower than that in a state where the fluctuation condition is not met. The predetermined timing may be a timing when the state where the fluctuation condition is not met has switched to a state where the fluctuation condition is met.

In the electricity supply system according to the first aspect of this disclosure, the control device may be configured to, when the second condition is met at a predetermined timing, control the solar converter in the specific control such that the electricity output by the solar converter becomes lower than that in a state where the fluctuation condition is not met. The predetermined timing may be a timing when the state where the fluctuation condition is not met has switched to a state where the fluctuation condition is met.

In the electricity supply system according to the first aspect of this disclosure, the control device may be configured to, when the second condition is met at a predetermined timing, control the group of auxiliaries in the specific control such that the electricity consumed by the group of auxiliaries becomes higher than that in a state where the fluctuation condition is not met. The predetermined timing may be a timing when the state where the fluctuation condition is not met has switched to a state where the fluctuation condition is met.

A second aspect of this disclosure is a control device configured to execute control of a solar converter, a group of auxiliaries, and a bidirectional converter as a processor executes instructions stored in a storage medium. The control device includes the processor. The control device is configured to apply the control to a vehicle. The vehicle includes: a solar panel; the solar converter that is able to convert electricity output by the solar panel and output the electricity; a group of auxiliaries that is supplied with the electricity output by the solar converter; a battery; and the bidirectional converter that is able to convert a voltage of electricity output by the battery and supply the electricity to the group of auxiliaries, as well as to convert a voltage of the electricity output by the solar converter and supply the electricity to the battery. As switching control, the control device is configured to, when the electricity output by the solar converter is higher than electricity consumed by the group of auxiliaries, control the bidirectional converter such that the electricity is directed from the solar converter to the battery, and when the electricity output by the solar converter is lower than the electricity consumed by the group of auxiliaries, control the bidirectional converter such that the electricity is directed from the battery to the group of auxiliaries. The control device is configured to execute specific control during a period when a fluctuation condition is met. The fluctuation condition is a condition that is set beforehand as a condition showing that fluctuation in at least either the electricity output by the solar panel or the electricity consumed by the group of auxiliaries is large. The specific control is control configured to control one or more selected from the solar converter, the group of auxiliaries, and the bidirectional converter such that a magnitude relationship between the electricity output by the solar converter and the electricity consumed by the group of auxiliaries remains the same.

A third aspect of this disclosure is a non-transitory storage medium storing instructions that are executable by one or more processors and that cause the one or more processors of a control device to perform the following functions. The functions include: executing switching control that, when electricity output by a solar converter is higher than electricity consumed by a group of auxiliaries, controls a bidirectional converter such that the electricity is directed from the solar converter to a battery, whereas when the electricity output by the solar converter is lower than the electricity consumed by the group of auxiliaries, controls the bidirectional converter such that the electricity is directed from the battery to the group of auxiliaries; and executing specific control during a period when a fluctuation condition is met. The fluctuation condition is a condition that is set beforehand as a condition showing that fluctuation in at least either electricity output by a solar panel or the electricity consumed by the group of auxiliaries is large. The specific control is control that controls one or more selected from the solar converter, the group of auxiliaries, and the bidirectional converter such that a magnitude relationship between the electricity output by the solar converter and the electricity consumed by the group of auxiliaries remains the same. The functions are applied to a vehicle. The vehicle includes: the solar panel; the solar converter that is able to convert the electricity output by the solar panel and output the electricity; the group of auxiliaries that is supplied with the electricity output by the solar converter; the battery; the bidirectional converter that is able to convert a voltage of electricity output by the battery and supply the electricity to the group of auxiliaries, as well as to convert a voltage of the electricity output by the solar converter and supply the electricity to the battery; and the control device configured to control the solar converter, the group of auxiliaries, and the bidirectional converter.

According to each of the above-described technical ideas, burden on the bidirectional converter can be reduced.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a view schematically representing the general configuration of a vehicle; and

FIG. 2 is a flowchart showing a processing routine executed by a control device.

### DETAILED DESCRIPTION OF EMBODIMENTS

In the following, one embodiment of an electricity supply system, a control device of a vehicle, and a program for a vehicle will be described with reference to the drawings.

### Overall Configuration

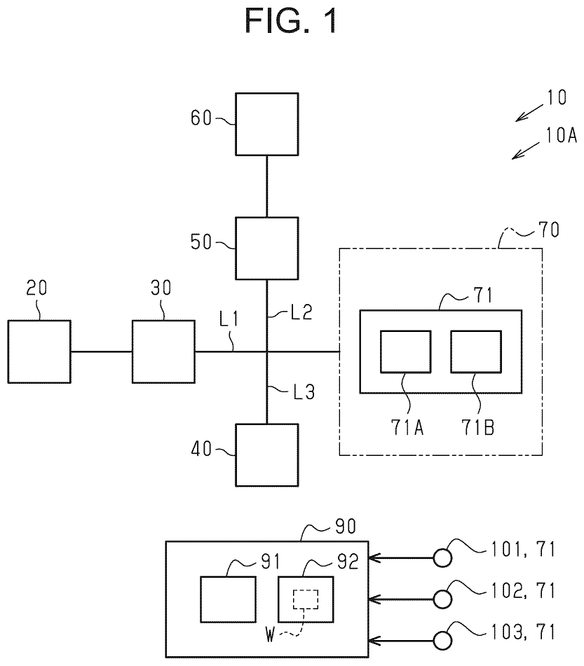

As shown in FIG. 1, a vehicle 10 includes an electricity supply system 10A. The electricity supply system 10A includes a first battery 60, a second battery 40, a solar panel 20, a solar converter 30, a bidirectional converter 50, and a group of auxiliaries 70.

The first battery 60 is a secondary battery. The first battery 60 is a high-voltage battery for the vehicle 10 to travel. The first battery 60 supplies electricity to one or more motors that make the vehicle 10 travel. A rated voltage of the first battery 60 is, for example, about 200 [V] to 250 [V].

The second battery 40 is a secondary battery. The second battery 40 is a battery for the group of auxiliaries 70. A rated voltage of the second battery 40 is lower than that of the first battery 60. The rated voltage of the second battery 40 is, for example, about 12 [V] to 48 [V].

The solar panel 20 has a configuration in which a plurality of solar cells, each generating electricity by being irradiated with sunlight, is arrayed into a panel form. The solar panel 20 is installed, for example, on a roof of the vehicle 10.

The solar converter 30 is electrically connected to the solar panel 20. The solar converter 30 is a circuit that converts a voltage of direct-current electricity input from the solar panel 20 and outputs the converted electricity. The solar converter 30 sometimes steps down and sometimes steps up the electricity output by the solar panel 20.

The group of auxiliaries 70 is a group of a plurality of auxiliaries 71. In FIG. 1, one of the plurality of auxiliaries 71 is shown as a representative. Details of the auxiliary 71 will be described later. The group of auxiliaries 70 is electrically connected to the solar converter 30. The group of auxiliaries 70 is supplied with the electricity output by the solar converter 30.

An electricity path leading from the solar panel 20 to the group of auxiliaries 70 via the solar converter 30 will be referred to as a first path L1. The above-described first battery 60 is located on a second path L2 that is an electricity path branching off from an intermediate point in the first path L1. The above-described second battery 40 is located on a third path L3 that is an electricity path branching off from the first path L1. Thus, the second battery 40 is electrically connected to both of the solar converter 30 and the group of auxiliaries 70. The second battery 40 allows the electricity output by the solar converter 30 to be charged. The second battery 40 can discharge electricity stored therein to the group of auxiliaries 70.

The bidirectional converter 50 is located at an intermediate point in the second path L2. Thus, the bidirectional converter 50 is electrically connected to the solar converter 30 as well as the group of auxiliaries 70. The bidirectional converter 50 is also electrically connected to the first battery 60. The bidirectional converter 50 is a circuit that converts a voltage of direct-current electricity input into it and outputs the converted electricity. The bidirectional converter 50 is a circuit that can switch the direction of electricity supply. The bidirectional converter 50 can convert a voltage of the electricity output by the solar converter 30 and supplies the converted electricity to the first battery 60. Specifically, the bidirectional converter 50 can step up the electricity output by the solar converter 30 and supply the stepped-up electricity to the first battery 60. The bidirectional converter 50 can convert a voltage of electricity output by the first battery 60 and supply the converted electricity to the group of auxiliaries 70. Specifically, the bidirectional converter 50 can step down the electricity output by the first battery 60 and supply the stepped-down electricity to the group of auxiliaries 70.

### Auxiliaries

The auxiliaries 71 are devices of which the operation does not require as high a voltage as the output voltage of the first battery 60. Each auxiliary 71 includes an auxiliary ECU 71A and a target device 71B that operates according to a command signal from the auxiliary ECU 71A. One example of the auxiliaries 71 is an electric power steering device that adjusts a steered angle of turning wheels in the vehicle 10. Other examples of the auxiliaries 71 include a display device, an acoustic device, an air-conditioning device, lighting devices such as cabin lights and headlights, a wiper device, and surroundings monitoring devices such as a camera and a radar. Some types of auxiliaries 71 include an input device, for example, an input switch, for a user to give instructions about the operation of the auxiliary 71. The input device outputs a signal according to the user's manipulation to a control device 90 to be described later.

The auxiliary ECU 71A is a computer including a processing circuit. The processing circuit includes a CPU and a memory. In the memory, various programs describing processes to be executed by the CPU and various pieces of data required for the CPU to execute the programs are stored beforehand. The auxiliary ECU 71A controls the target device 71B based on a command signal from the control device 90 to be described later. The auxiliary ECU 71A switches between a sleep state and an active state. The sleep state is a state where an activation command from the control device 90 is waited for while various processes are in pause. In the sleep state, electricity consumed by the auxiliary ECU 71A per unit time is lower than that in the active state. The auxiliary ECU 71A controls the target device 71B when the auxiliary ECU 71A is in the active state. Some auxiliary ECUs 71A can operate the target device 71B in different electricity modes. The electricity modes include a normal electricity mode and an electricity saving mode. In the electricity saving mode, the electricity consumed by the target device 71B per unit time is lower than that in the normal electricity mode. Hereinafter, those auxiliaries 71 among the group of auxiliaries 70 that can switch the electricity mode will be referred to as switchable auxiliaries.

Some of the plurality of auxiliaries 71 are various sensors. Examples of the various sensors include a first sensor 101, a plurality of second sensors 102, and a temperature sensor 103. In FIG. 1, one of the plurality of second sensors 102 is shown as a representative. The first sensor 101 repeatedly detects the current and the voltage output by the solar converter 30 on a predetermined detection cycle. The second sensor 102 is provided for each auxiliary 71. The second sensor 102 repeatedly detects a current flowing through the target auxiliary 71 and a voltage applied to the target auxiliary 71 on a predetermined detection cycle. The temperature sensor 103 repeatedly detects a temperature of the second battery 40 on a predetermined detection cycle. There are various other sensors as the auxiliaries 71. One example of the other sensors is a sensor that detects a steering angle of a steering wheel. The various sensors repeatedly output signals according to information they have detected to the control device 90 to be described later.

### Control Device

The electricity supply system 10A includes the control device 90. The control device 90 is a computer including a processing circuit. The processing circuit includes a CPU 91 and a memory 92. In the memory 92, various programs W for the vehicle that describe processes to be executed by the CPU 91 and various pieces of data required for the CPU 91 to execute the programs W are stored beforehand. The control device 90 acquires signals from the above-described various sensors and input devices as needed. The control device 90 calculates required parameters based on the acquired information. For example, the control device 90 calculates the electricity output by the solar converter 30 based on a detection signal of the first sensor 101. The control device 90 calculates electricity consumed by the group of auxiliaries 70 based on detection signals of the plurality of second sensors 102. The electricity consumed by the group of auxiliaries 70 refers to the sum of electricity consumed by all the auxiliaries 71. The control device 90 repeats the calculation of the electricity output by the solar converter 30 and the electricity consumed by the group of auxiliaries 70 on a predetermined calculation cycle.

The control device 90 controls the solar converter 30, the bidirectional converter 50, and the group of auxiliaries 70 as the CPU 91 executes the programs W stored in the memory 92. To control the solar converter 30, the bidirectional converter 50, and the group of auxiliaries 70, the control device 90 basically performs modes of basic control to be described below that are specifically intended for these respective devices.

### Basic Control for Solar Converter

First, a PV characteristic line that is a premise for the basic control for the solar converter 30 will be described. An orthogonal coordinate system with the voltage output by the solar converter 30 plotted on the X-axis and the electricity output by the solar converter 30 plotted on the Y-axis will be considered. In this orthogonal coordinate system, the PV characteristic line represents a correspondence relationship between the voltage output by the solar converter 30 and the electricity output by the solar converter 30 that the solar converter 30 can realize according to a status of electricity generation by the solar panel 20 at the current point in time. The PV characteristic line has basically a mountain-shaped distribution. Specifically, on the PV characteristic line, there is a local maximum point at which the electricity output by the solar converter 30 shifts from increasing to decreasing as the voltage output by the solar converter 30 increases. The electricity output at this local maximum point will be referred to as maximum electricity. In the basic control for the solar converter 30, the control device 90 controls the solar converter 30 such that the electricity output by the solar converter 30 becomes the maximum electricity. Specifically, on a predetermined cycle, for example, a one-minute cycle, the control device 90 searches for an output voltage at which the maximum electricity can be obtained at the current point in time. Then, the control device 90 controls the solar converter 30 for a certain period so as to output that output voltage and therefore the maximum electricity. The control device 90 repeats the search for the maximum electricity and the control of the solar converter 30 according to the search result.

### Basic Control for Bidirectional Converter

The basic control for the bidirectional converter 50 is control relating to a voltage output by the bidirectional converter 50. In this basic control, when the destination of electricity supply by the bidirectional converter 50 is the first battery 60, the control device 90 steps up the voltage output by the solar converter 30 to a voltage equivalent to the rated voltage of the first battery 60 and outputs the stepped-up voltage to the first battery 60. On the other hand, when the destination of electricity supply by the bidirectional converter 50 is the group of auxiliaries 70, the control device 90 steps down the voltage output by the first battery 60 to a voltage equivalent to the rated voltage of the second battery 40 and outputs the stepped-down voltage to the group of auxiliaries 70.

### Basic Control for Auxiliaries

Based on signals from the various input devices and sensors, etc., the control device 90 can grasp the auxiliaries 71 of which the operation is requested at the current point in time and the electricity mode specified. In the basic control for the auxiliaries 71, the control device 90 controls the auxiliaries 71 of which the operation is requested at the current point in time in the electricity mode as requested. In essence, the control device 90 controls each auxiliary 71 of which the operation is requested at the current point in time by outputting a command signal to the auxiliary 71. Hereinafter, the description that the control device 90 outputs a command signal in controlling each auxiliary 71 will not be individually given.

### Switching Control for Bidirectional Converter

The control device 90 constantly performs switching control in controlling the bidirectional converter 50. The switching control is control for switching the direction of electricity supply by the bidirectional converter 50. In the switching control, the control device 90 switches the direction of electricity supply by the bidirectional converter 50 according to a magnitude relationship at that point in time between the electricity output by the solar converter 30 and the electricity consumed by the group of auxiliaries 70. When the electricity output by the solar converter 30 is higher than the electricity consumed by the group of auxiliaries 70, the control device 90 controls the bidirectional converter 50 such that the electricity is directed from the solar converter 30 to the first battery 60. On the other hand, when the electricity output by the solar converter 30 is lower than the electricity consumed by the group of auxiliaries 70, the control device 90 controls the bidirectional converter 50 such that the electricity is directed from the first battery 60 to the group of auxiliaries 70.

### Specific Control

The control device 90 can execute specific control separately from the modes of basic control for the respective devices. The control device 90 performs the specific control during a period when a predetermined fluctuation condition is met. When performing the specific control, the control device 90 suspends the basic control for the solar converter 30 or for the auxiliaries 71 as necessary. Even during the period when the fluctuation condition is met, the control device 90 continues the switching control and the basic control for the bidirectional converter 50. The fluctuation condition in this embodiment is set beforehand as a condition showing that fluctuation in the electricity consumed by the group of auxiliaries 70 is large. Specifically, the fluctuation condition is that a difference between a maximum value and a minimum value of the electricity consumed by the group of auxiliaries 70 during a unit period is equal to or larger than a specified value. The unit period is set beforehand. The unit period is, for example, a few seconds. The specified value is set beforehand. As the specified value, such a value is set as to be able to grasp a situation where the electricity consumed by the group of auxiliaries 70 is so large that the magnitude relationship between the electricity output by the solar converter 30 and the electricity consumed by the group of auxiliaries 70 becomes reversed. In the control device 90, the unit period and the specified value are stored beforehand.

In the specific control, the control device 90 controls the solar converter 30, the group of auxiliaries 70, and the bidirectional converter 50 such that the magnitude relationship between the electricity output by the solar converter 30 and the electricity consumed by the group of auxiliaries 70 remains the same. The control device 90 in this embodiment executes the specific control based on a requisite condition that the temperature of the second battery 40 is outside a predetermined range. The predetermined range is set beforehand as a temperature range within which the charge-discharge performance of the second battery 40 does not degrade. In the control device 90, an allowable lower limit value that is a lower limit value of the predetermined range and an allowable upper limit value that is an upper limit value of the predetermined range are stored beforehand. As the allowable lower limit value, for example, a temperature below a freezing point can be set. As the allowable upper limit value, for example, a temperature equal to or higher than 50 degrees can be set.

The specific control includes first specific control and second specific control. The control device 90 performs the first specific control when the electricity output by the solar converter 30 is higher than the electricity consumed by the group of auxiliaries 70 at a timing when a state where the fluctuation condition is not met has switched to a state where the fluctuation condition is met. The first specific control is control for maintaining the state where the electricity output by the solar converter 30 is higher than the electricity consumed by the group of auxiliaries 70. On the other hand, the control device 90 performs the second specific control when the electricity output by the solar converter 30 is lower than the electricity consumed by the group of auxiliaries 70 at the timing when the state where the fluctuation condition is not met has switched to the state where the fluctuation condition is met. The second specific control is control for maintaining the state where the electricity output by the solar converter 30 is lower than the electricity consumed by the group of auxiliaries 70.

The first specific control includes first specific control for the bidirectional converter 50 and first specific control for the group of auxiliaries 71. In the first specific control for the bidirectional converter 50, while maintaining the above-described control of the output voltage relating to the basic control for the bidirectional converter 50, the control device 90 controls the bidirectional converter 50 such that the electricity supplied from the bidirectional converter 50 to the first battery 60 becomes lower than that in the state where the fluctuation condition is not met. In the first specific control for the auxiliaries 71, the control device 90 controls the group of auxiliaries 70 such that the electricity consumed by the group of auxiliaries 70 becomes lower than that in the state where the fluctuation condition is not met. Thus, when the first specific control for the bidirectional converter 50 is being executed, the electricity supplied from the bidirectional converter 50 to the first battery 60 is lower compared with that when the first specific control for the bidirectional converter 50 is not being executed. When the first specific control for the auxiliaries 71 is being executed, the electricity consumed by the group of auxiliaries 70 is lower compared with that when the above-described basic control for the auxiliaries 71 is being executed.

The second specific control includes second specific control for the solar converter 30 and second specific control for the auxiliaries 71. In the second specific control for the solar converter 30, the control device 90 controls the solar converter 30 such that the electricity output by the solar converter 30 becomes lower than that in the state where the fluctuation condition is not met. In the second specific control for the auxiliaries 71, the control device 90 controls the group of auxiliaries 70 such that the electricity consumed by the group of auxiliaries 70 becomes higher than that in the state where the fluctuation condition is not met. Thus, when the second specific control for the solar converter 30 is being executed, the electricity output by the solar converter 30 is lower compared with that when the above-described basic control for the solar converter 30 is being executed. When the second specific control for the auxiliaries 71 is being executed, the electricity consumed by the group of auxiliaries 70 is higher compared with that when the above-described basic control for the auxiliaries 71 is being executed.

### Processing Routine

By executing the programs W, the control device 90 repeats a sequential processing routine described below. The control device 90 thereby executes the specific control as necessary. This processing routine is repeatedly executed when the control device 90 is being driven. Therefore, even when the vehicle 10 is stationary or parked, the following sequential processing routine is repeatedly executed as long as electricity enough to drive the control device 90 is supplied to the control device 90.

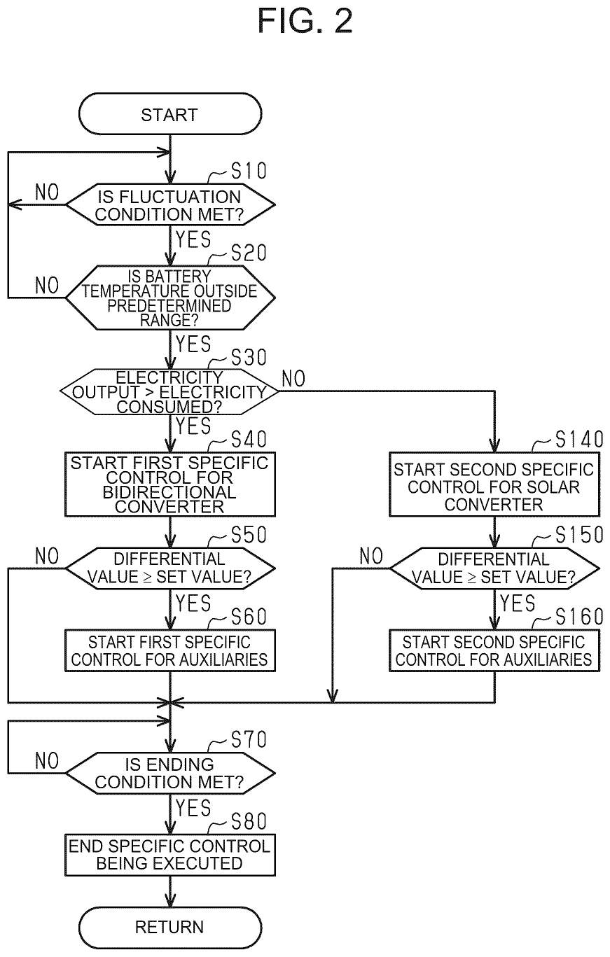

As shown in FIG. 2, after starting the processing routine, the control device 90 first executes a process of step S10. In step S10, the control device 90 determines whether the fluctuation condition is met. Specifically, until a unit period has passed since the process of step S10 has been started, the control device 90 monitors transition of the electricity consumed by the group of auxiliaries 70. Then, the control device 90 identifies the maximum value and the minimum value of the electricity consumed during the unit period. Then, the control device 90 determines whether a differential value that is a value obtained by subtracting the minimum value from the maximum value is equal to or larger than the specified value. When the differential value is smaller than the specified value, the control device 90 determines that the fluctuation condition is not met (step S10: NO). In this case, the control device 90 executes the process of step S10 again. The control device 90 repeats the process of step S10 until the differential value becomes equal to or larger than the specified value, i.e., until the fluctuation condition is met. When the fluctuation condition is met (step S10: YES), the control device 90 proceeds to a process of step S20. A situation where the determination in step S10 yields a YES is a situation where the state where the fluctuation condition is not met has switched to the state where the fluctuation condition is met.

In step S20, the control device 90 determines whether the temperature of the second battery 40 is outside the predetermined range. The control device 90 compares the latest value of the temperature of the second battery 40 with the allowable lower limit value and the allowable upper limit value. When the temperature of the second battery 40 is equal to or higher than the allowable lower limit value and equal to or lower than the allowable upper limit value (step S20: NO), the control device 90 returns to the process of step S10.

On the other hand, when the temperature of the second battery 40 is lower than the allowable lower limit value or this temperature is higher than the allowable upper limit value (step S20: YES), the control device 90 proceeds to a process of step S30. When the determination in step S20 yields a YES, this means that the requisite condition for executing the specific control is met.

In step S30, the control device 90 determines whether the electricity output by the solar converter 30 is higher than the electricity consumed by the group of auxiliaries 70. The control device 90 compares the latest value of the electricity output by the solar converter 30 and the latest value of the electricity consumed by the group of auxiliaries 70. Here, at the point in time when step S30 is reached, the control device 90 is performing the basic control for the solar converter 30. Therefore, the electricity output by the solar converter 30 at this point in time is the maximum electricity on the PV characteristic line at the current point in time. When the electricity output by the solar converter 30 is higher than the electricity consumed by the group of auxiliaries 70 (step S30: YES), the control device 90 proceeds to a process of step S40. After the determination in step S10 yields a YES, the control device 90 promptly performs the processes of step S20 and step S30. Thus, the timing when the control device 90 performs the process of step S30 corresponds to the timing when the state where the fluctuation condition is not met has switched to the state where the fluctuation condition is met.

In step S40, the control device 90 starts the first specific control for the bidirectional converter 50. Here, in a situation where the processing proceeds to step S40, in connection with the switching control for the bidirectional converter 50, the destination of electricity supply by the bidirectional converter 50 is the first battery 60. In the first specific control for the bidirectional converter 50, the control device 90 controls the bidirectional converter 50 such that the electricity supplied from the bidirectional converter 50 to the first battery 60 becomes lower than that before execution of the first specific control and therefore in the state where the fluctuation condition is not met. After starting the first specific control for the bidirectional converter 50 in step S40, the control device 90 proceeds to a process of step S50.

In step S50, the control device 90 determines whether the differential value calculated in the most recent process of step S10 is equal to or larger than a set value. The set value is set beforehand as such a value as to be able to grasp that fluctuation in the electricity consumed by the group of auxiliaries 70 is considerably large. The set value is stored in the control device 90 beforehand. When the differential value is smaller than the set value (step S50: NO), the control device 90 skips a process of step S60 to be described later and proceeds to a process of step S70. On the other hand, when the differential value is equal to or larger than the set value (step S50: YES), the control device 90 proceeds to the process of step S60.

In step S60, the control device 90 starts the first specific control for the auxiliaries 71. In this case, the control device 90 suspends the basic control for the auxiliaries 71. In the first specific control for the auxiliaries 71, the control device 90 controls, among auxiliaries 71 of which the operation is requested at the current point in time, all switchable auxiliaries in the electricity saving mode. In the first specific control for the auxiliaries 71, the control device 90 controls, among the auxiliaries 71 of which the operation is requested at the current point in time, all the other auxiliaries 71 than the switchable auxiliaries as at normal times. When the control device 90 starts the first specific control for the auxiliaries 71, the switchable auxiliaries switch from the normal electricity mode to the electricity saving mode. Accordingly, the electricity consumed by the group of auxiliaries 70 decreases by an amount corresponding to the number of auxiliaries 71 that have switched to the electricity saving mode. As a result, when the first specific control for the auxiliaries 71 is being executed, the electricity consumed by the group of auxiliaries 70 is lower compared with that before execution of the first specific control and therefore in the state where the fluctuation condition is not met. Thus, in the first specific control for the auxiliaries 71, the control device 90 controls the group of auxiliaries 70 such that the electricity consumed by the group of auxiliaries 70 becomes lower than that in the state where the fluctuation condition is not met. During execution of the first specific control for the auxiliaries 71, the control device 90 displays, on the display device, to the effect that each auxiliary 71 is being operated in the electricity saving mode with the objective of protecting parts. After starting the first specific control for the auxiliaries 71 in step S60, the control device 90 proceeds to the process of step S70.

In step S70, the control device 90 determines whether an ending condition is met. The ending condition is that the difference between the maximum value and the minimum value of the electricity consumed by the group of auxiliaries 70 during the unit period is smaller than the specified value. Due to the relationship between the ending condition and the fluctuation condition, the control device 90 performs the determination with affirmation and negation reversed from the process of step S10. As in step S10, the control device 90 monitors the transition of the electricity consumed by the group of auxiliaries 70 until the unit period has passed since the processing has proceeded to step S70. Then, the control device 90 determines whether the ending condition is met based on the difference between the maximum value and the minimum value of the electricity consumed that is grasped from this transition. When the ending condition is not met (step S70: NO), the control device 90 performs the process of step S70 again. The control device 90 repeats the process of step S70 until the ending condition is met. When the ending condition is met (step S70: YES), the control device 90 proceeds to the process of step S80. A situation where the determination in step S70 yields a YES is a situation where the state where the fluctuation condition is met has switched to the state where the fluctuation condition is not met.

In step S80, the control device 90 ends all modes of specific control that are being executed. Then, the control device 90 resumes each mode of basic control that has been suspended to execute the specific control. Thereafter, the control device 90 executes the process of step S10 again.

When the electricity output by the solar converter 30 is equal to or lower than the electricity consumed by the group of auxiliaries 70 in step S30 (step S30: NO), the control device 90 proceeds to a process of step S140.

In step S140, the control device 90 starts the second specific control for the solar converter 30. In this case, the control device 90 suspends the basic control for the solar converter 30. In the second specific control for the solar converter 30, the control device 90 controls the solar converter 30 such that the electricity output by the solar converter 30 becomes specific electricity. The specific electricity in this embodiment is a value of half the maximum electricity according to the basic control for the solar converter 30 that has been executed until just before that point in time. As can be seen from the magnitude relationship between the maximum electricity and the specific electricity, in the second specific control for the solar converter 30, the control device 90 controls the solar converter 30 such that the electricity output by the solar converter 30 becomes lower than that before execution of the second specific control and therefore in the state where the fluctuation condition is not met. After starting the second specific control for the solar converter 30 in step S140, the control device 90 proceeds to a process of step S150.

In step S150, the control device 90 performs the same process as in step S50. When the differential value is smaller than the set value (step S150: NO), the control device 90 skips a process of step S160 to be described later and proceeds to the process of step S70. On the other hand, when the differential value is equal to or larger than the set value (step S150: YES), the control device 90 proceeds to the process of step S160.

In step S160, the control device 90 starts the second specific control for the auxiliaries 71. In this case, the control device 90 suspends the basic control for the auxiliaries 71. In the second specific control for the auxiliaries 71, the control device 90 controls those auxiliaries 71 of which the operation is requested at the current point in time as requested and, in addition, controls the auxiliary ECUs 71A of all the auxiliaries 71 of which the operation is not requested into the active state. Thus, when the control device 90 starts the second specific control for the auxiliaries 71, all the auxiliary ECUs 71A that have been in the sleep state switch to the active state. Accordingly, the electricity consumed by the group of auxiliaries 70 increases by an amount corresponding to the number of auxiliary ECUs 71A that have switched to the active state. As a result, when the second specific control for the auxiliaries 71 is being executed, the electricity consumed by the group of auxiliaries 70 is higher compared with that before execution of the second specific control and therefore in the state where the fluctuation condition is not met. Thus, in the second specific control for the auxiliaries 71, the control device 90 controls the group of auxiliaries 70 such that the electricity consumed by the group of auxiliaries 70 becomes higher than that in the state where the fluctuation condition is not met. After starting the second specific control for the auxiliaries 71 in step S160, the control device 90 proceeds to the process of step S70. Then, the control device 90 performs the processes of step S70 and step S80.

### Workings of Embodiment

As the control device 90 executes the above-described processing routine, a first aspect or a second aspect as follows is realized.

The first aspect will be described. Now, it is assumed that in the situation where the temperature of the second battery 40 is outside the predetermined range, the state where the fluctuation condition is not met has switched to the state where it is met (step S10: YES, step S20: YES). It is assumed then that at this point in time the electricity output by the solar converter 30 is higher than the electricity consumed by the group of auxiliaries 70 (step S30: YES). In this case, due to the settings of the switching control for the bidirectional converter 50, the destination of electricity supply by the bidirectional converter 50 is the first battery 60. In such a situation, the control device 90 performs the first specific control for the bidirectional converter 50 (step S40). That is, the control device 90 reduces the electricity supplied from the bidirectional converter 50 to the first battery 60. This leads to the electricity being accumulated between the solar converter 30 and the bidirectional converter 50, which creates a situation where there is a margin for supplying additional electricity to the group of auxiliaries 70. Further, when the fluctuation in the electricity consumed by the group of auxiliaries 70 is considerably large (step S50: YES), the control device 90 performs the first specific control for the auxiliaries 71 (step S60). That is, the control device 90 performs switching to the electricity saving mode for the auxiliaries 71 of which the electricity mode is switchable. Accordingly, the electricity consumed by the group of auxiliaries 70 decreases. Thus, when the first specific control is performed, the margin for supplying additional electricity to the group of auxiliaries 70 increases while the electricity consumed by the group of auxiliaries 70 decreases. Accordingly, the difference between the electricity output by the solar converter 30 and the electricity consumed by the group of auxiliaries 70 becomes so large that, even when the electricity consumed by the group of auxiliaries 70 fluctuates, the magnitude relationship between the electricity output and the electricity consumed does not become reversed. Therefore, during the period when the fluctuation condition is met, the state where the electricity output by the solar converter 30 is higher than the electricity consumed by the group of auxiliaries 70 is maintained. Due to the settings of the switching control for the bidirectional converter 50, the destination of electricity supply by the bidirectional converter 50 remains the first battery 60. In the case where the determination in step S50 yields a NO, when the control device 90 simply performs the first specific control for the bidirectional converter 50 between the first specific control for the bidirectional converter 50 and the first specific control for the auxiliaries 71, the following is realized: The difference between the electricity output by the solar converter 30 and the electricity consumed by the group of auxiliaries 70 becomes so large that, even when the electricity consumed by the group of auxiliaries 70 fluctuates, the magnitude relationship between the electricity output and the electricity consumed does not become reversed.

The second aspect will be described. Now, it is assumed that in the situation where the temperature of the second battery 40 is outside the predetermined range, the state where the fluctuation condition is not met has switched to the state where it is met (step S10: YES, step S20: YES). It is assumed then that at this point in time the electricity output by the solar converter 30 is lower than the electricity consumed by the group of auxiliaries 70 (step S30: NO). In this case, due to the settings of the switching control for the bidirectional converter 50, the destination of electricity supply by the bidirectional converter 50 is the group of auxiliaries 70. In such a situation, the control device 90 performs the second specific control for the solar converter 30 (step S140). That is, the control device 90 makes the electricity output by the solar converter 30 lower than the maximum electricity on the PV characteristic line. Further, when the fluctuation in the electricity consumed by the group of auxiliaries 70 is considerably large (step S150: YES), the control device 90 performs the second specific control for the auxiliaries 71 (step S160). That is, the control device 90 puts each auxiliary ECU 71A that has been in the sleep state into the active state. Accordingly, the electricity consumed by the group of auxiliaries 70 increases. Thus, when the second specific control is performed, the electricity output by the solar converter 30 decreases while the electricity consumed by the group of auxiliaries 70 increases. Accordingly, the difference between the electricity output by the solar converter 30 and the electricity consumed by the group of auxiliaries 70 becomes so large that, even when the electricity consumed by the group of auxiliaries 70 fluctuates, the magnitude relationship between the electricity output and the electricity consumed does not become reversed. Therefore, during the period when the fluctuation condition is met, the state where the electricity output by the solar converter 30 is lower than the electricity consumed by the group of auxiliaries 70 is maintained. Due to the settings of the switching control for the bidirectional converter 50, the destination of electricity supply by the bidirectional converter 50 remains the group of auxiliaries 70. In the case where the determination in step S150 yields a NO, when the control device 90 simply performs the second specific control for the solar converter 30 between the second specific control for the solar converter 30 and the second specific control for the auxiliaries 71, the following is realized: The difference between the electricity output by the solar converter 30 and the electricity consumed by the group of auxiliaries 70 becomes so large that, even when the electricity consumed by the group of auxiliaries 70 fluctuates, the magnitude relationship between the electricity output and the electricity consumed does not become reversed.

### Advantages of Embodiment

(1) As described above in Workings of Embodiment, in the configuration of the embodiment, each device is controlled during the period when the fluctuation condition is met such that the magnitude relationship between the electricity output by the solar converter 30 and the electricity consumed by the group of auxiliaries 70 remains the same. This increases the likelihood that the destination of electricity supply by the bidirectional converter 50 remains the same during the period when the fluctuation condition is met. Thus, even in a situation where the destination of electricity supply by the bidirectional converter 50 can switch frequently according to the related art, burden on the bidirectional converter 50 can be minimized.
(2) For example, when there are repeated straight sections and curved sections in a travel route of the vehicle 10, the electric power steering device is driven and stopped repeatedly. In this case, the electricity consumed by the group of auxiliaries 70 can fluctuate significantly. The electricity consumed by the group of auxiliaries 70 can also fluctuate significantly, for example, as the air-conditioning device or the headlights are repeatedly turned on and off. If the fluctuation condition using the degree of fluctuation in the electricity consumed by the group of auxiliaries 70 as an index is adopted as in the embodiment, the aforementioned situations where the electricity consumed by the group of auxiliaries 70 fluctuates significantly can be grasped. Thereby the burden on the bidirectional converter 50 in the situation where the fluctuation in the electricity consumed by the group of auxiliaries 70 is large can be minimized.
(3) When the temperature of the second battery 40 is within the predetermined range, the second battery 40 fulfils a sufficient charge-discharge function. In this case, when the electricity consumed by the group of auxiliaries 70 fluctuates, excess or shortage of the electricity supplied from the solar converter 30 relative to the electricity consumed by the group of auxiliaries 70 can be compensated for by charge or discharge of the second battery 40. Thereby the magnitude relationship between the electricity output by the solar converter 30 and the electricity consumed by the group of auxiliaries 70 can be maintained. On the other hand, when the temperature of the second battery 40 is excessively low or high, the charge-discharge performance of the second battery 40 can degrade. In such a situation, the aforementioned excess or shortage of the electricity accompanying the fluctuation in the electricity consumed by the group of auxiliaries 70 may fail to be compensated for by charge or discharge of the second battery 40. In the embodiment, the specific control is performed only in such a situation. Here, when the specific control is performed, control restrictions different from those at normal times are imposed, which can have various influences, for example, that another control that is being performed in conjunction with the basic control is also changed. The configuration of the embodiment can preclude unnecessarily increasing the opportunities to perform the specific control.
(4) As described above in the first aspect of Workings of Embodiment, in the configuration of the embodiment, the electricity supplied from the bidirectional converter 50 to the first battery 60 is reduced when the electricity output by the solar converter 30 is higher than the electricity consumed by the group of auxiliaries 70 at the point in time of switching to the state where the fluctuation condition is met. As described above in Workings of Embodiment, this leads to an increased margin for supplying additional electricity to the group of auxiliaries 70. Here, since the solar converter 30 is outputting the maximum electricity on the PV characteristic line, it is difficult for the solar converter 30 to make the electricity output any higher by itself. In the configuration of the embodiment, the margin for supplying electricity to the group of auxiliaries 70 can be increased even in such a situation by adjusting the electricity output by the bidirectional converter 50. This configuration of the embodiment is favorable in maintaining the state where the electricity output by the solar converter 30 is higher than the electricity consumed by the group of auxiliaries 70.
(5) As described above in the first aspect of Workings of Embodiment, in the configuration of the embodiment, switching to the electricity saving mode is performed for the auxiliaries 71 of which the electricity mode is switchable when the electricity output by the solar converter 30 is higher than the electricity consumed by the group of auxiliaries 70, and moreover the fluctuation in the electricity consumed by the group of auxiliaries 70 is considerably large, at the point in time of switching to the state where the fluctuation condition is met. Accordingly, the electricity consumed by the group of auxiliaries 70 decreases. In this configuration of the embodiment, even when the fluctuation in the electricity consumed by the group of auxiliaries 70 is considerably large, the state where the electricity output by the solar converter 30 is higher than the electricity consumed by the group of auxiliaries 70 can be reliably maintained. As the auxiliaries 71 are switched to the electricity saving mode only when the fluctuation in the electricity consumed by the group of auxiliaries 70 is considerably large, opportunities to compel the auxiliaries 71 to change their operation modes can be minimized.
(6) As described above in the second aspect of Workings of Embodiment, in the configuration of the embodiment, the electricity output by the solar converter 30 is reduced when the electricity output by the solar converter 30 is lower than the electricity consumed by the group of auxiliaries 70 at the point in time of switching to the state where the fluctuation condition is met. This configuration of the embodiment is favorable in maintaining the state where the electricity output by the solar converter 30 is lower than the electricity consumed by the group of auxiliaries 70.
(7) As described above in the second aspect of Workings of Embodiment, in the configuration of the embodiment, the auxiliary ECUs 71A that have been in the sleep state are put into the active state when the electricity output by the solar converter 30 is lower than the electricity consumed by the group of auxiliaries 70, and moreover the fluctuation in the electricity consumed by the group of auxiliaries 70 is considerably large, at the point in time of switching to the state where the fluctuation condition is met. Accordingly, the electricity consumed by the group of auxiliaries 70 increases. In this configuration of the embodiment, even when the fluctuation in the electricity consumed by the group of auxiliaries 70 is considerably large, the state where the electricity output by the solar converter 30 is lower than the electricity consumed by the group of auxiliaries 70 can be reliably maintained. If a measure to maintain this magnitude relationship is simply to put the auxiliary ECUs 71A into the active state, since it does not involve starting the target devices 71B or changing the operation modes of the target devices 71B, the behavior of the vehicle 10 essentially does not change at all. Therefore, the user is not affected either.

### Modified Examples

The above-described embodiment can be implemented with changes made thereto as follows. The above-described embodiment and the following modified examples can be implemented in combination within such a range that no technical contradiction arises.
Regarding step S40, the contents of the first specific control for the bidirectional converter 50 are not limited to the example in the above-described embodiment. At a minimum, the first specific control for the bidirectional converter 50 should be able to control the bidirectional converter 50 such that the electricity supplied from the bidirectional converter 50 to the first battery 60 becomes lower than that in the state where the fluctuation condition is not met. At a minimum, the first specific control for the bidirectional converter 50 should be able to reduce one or more selected from the current and the voltage supplied from the bidirectional converter 50 to the first battery 60.
Regarding step S60, the contents of the first specific control for the auxiliaries 71 are not limited to the example in the above-described embodiment. At a minimum, the first specific control for the auxiliaries 71 should be able to control the group of auxiliaries 70 such that the electricity consumed by the group of auxiliaries 70 becomes lower than that in the state where the fluctuation condition is not met. For example, switchable auxiliaries to be switched to the electricity saving mode may be selected from among a plurality of switchable auxiliaries that is operating at the point in time of execution of step S60. In this case, the electricity consumed by each auxiliary 71 may be taken into account. Selecting switchable auxiliaries that consume high electricity as targets to be switched to the electricity saving mode is favorable in reducing the electricity consumed by the group of auxiliaries 70. In addition, for example, the number of auxiliaries 71 to be controlled into the electricity saving mode may be increased or decreased in the middle of execution of the first specific control for the auxiliaries 71.
In the first specific control for the auxiliaries 71, the operation of the auxiliaries 71 itself may be stopped. For example, a situation where the first specific control for the auxiliaries 71 is performed can be a situation where the vehicle is parked. In such a situation, monitoring of an outside or an inside of the vehicle by the camera can be unnecessary. In this case, the camera may be stopped.
The order of the process of step S40 and the process of step S60 may be reversed. The process of step S50 may be omitted. In addition to omitting the process of step S50, either the process of step S40 or the process of step S60 may be omitted. In short, at a minimum, the processes should be arranged such that when the determination in step S30 yields a YES, the state where the electricity output by the solar converter 30 is higher than the electricity consumed by the group of auxiliaries 70 can be maintained.
Regarding the processes after the determination in step S30 yields a YES, to maintain the state where the electricity output by the solar converter 30 is higher than the electricity consumed by the group of auxiliaries 70, the solar converter 30 may be controlled instead of or in addition to controlling the bidirectional converter 50 and the group of auxiliaries 70. For example, it is assumed that a mode of basic control for the solar converter 30 is adopted in which the electricity output by the solar converter 30 is set to a value lower than the maximum electricity on the PV characteristic line. In this case, the electricity output by the solar converter 30 is allowed to be further increased. In such a case, the magnitude relationship between the electricity output by the solar converter 30 and the electricity consumed by the group of auxiliaries 70 can be maintained by increasing the electricity output by the solar converter 30. Such control of the solar converter 30 may be adopted as the first specific control. Thus, the first specific control is not limited to the example in the above-described embodiment. At a minimum, the first specific control should be able to maintain the state where the electricity output by the solar converter 30 is higher than the electricity consumed by the group of auxiliaries 70. At a minimum, by controlling one or more selected from the solar converter 30, the group of auxiliaries 70, and the bidirectional converter 50, the first specific control should be able to maintain the magnitude relationship between the electricity output by the solar converter 30 and the electricity consumed by the group of auxiliaries 70 during a period when the fluctuation condition is met.
Regarding step S140, the contents of the second specific control for the solar converter 30 are not limited to the example in the above-described embodiment. At a minimum, the second specific control for the solar converter 30 should be able to control the solar converter 30 such that the electricity output by the solar converter 30 becomes lower than that in the state where the fluctuation condition is not met. The above-described specific electricity according to the second specific control for the solar converter 30 may be set to a value other than half the maximum electricity on the PV characteristic line. As in the above-described modified example of step S60, for example, the above-described specific electricity may be increased or decreased in the middle of execution of the second specific control for the solar converter 30.
Regarding step S160, the contents of the second specific control for the auxiliaries 71 are not limited to the example in the above-described embodiment. At a minimum, the second specific control for the auxiliaries 71 should be able to control the group of auxiliaries 70 such that the electricity consumed by the group of auxiliaries 70 becomes higher than that in the state where the fluctuation condition is not met. For example, among the switchable auxiliaries that are operating at the point in time of execution of step S160, those that are operating in the electricity saving mode may be switched to the normal electricity mode. As in the above-described modified example of step S60, for example, the number of auxiliary ECUs 71A to be controlled into the active state may be increased or decreased in the middle of execution of the second specific control for the auxiliaries 71.
The order of the process of step S140 and the process of step S160 may be reversed. The process of step S150 may be omitted. In addition to omitting the process of step S150, either the process of step S140 or the process of step S160 may be omitted. In short, at a minimum, the processes should be arranged such that when the determination in step S30 yields a NO, the state where the electricity output by the solar converter 30 is lower than the electricity consumed by the group of auxiliaries 70 can be maintained.
Regarding the processes after the determination in step S30 yields a NO, to maintain the state where the electricity output by the solar converter 30 is lower than the electricity consumed by the group of auxiliaries 70, the bidirectional converter 50 may be controlled instead of or in addition to controlling the solar converter 30 and the group of auxiliaries 70. The control of the bidirectional converter 50 may be adopted as the second specific control. Thus, as with the first specific control, the second specific control is not limited to the example in the above-described embodiment. At a minimum, the second specific control should be able to maintain the state where the electricity output by the solar converter 30 is lower than the electricity consumed by the group of auxiliaries 70. At a minimum, by controlling one or more selected from the solar converter 30, the group of auxiliaries 70, and the bidirectional converter 50, the second specific control should be able to maintain the magnitude relationship between the electricity output by the solar converter 30 and the electricity consumed by the group of auxiliaries 70 during a period when the fluctuation condition is met.
What is determined in step S30 is not limited to the example in the above-described embodiment. In other words, the manner of determining which of the first specific control and the second specific control to execute is not limited to the example in the above-described embodiment. For example, in step S30, which of the first specific control and the second specific control to execute may be determined based on a time period in a day. Here, in the case of night-time, the vehicle 10 is made to travel with the headlights on. Therefore, during night-time, the electricity consumed by the group of auxiliaries 70 is highly likely to increase. From this perspective, during night-time, the state where the electricity output by the solar converter 30 is lower than the electricity consumed by the group of auxiliaries 70 is likely to arise. Thus, it is highly likely that the state where the electricity output by the solar converter 30 is lower than the electricity consumed by the group of auxiliaries 70 can be maintained without the control contents being much changed from the basic control in performing the specific control. In step S30, therefore, whether the current time is in a night-time period or a day-time period may be determined. In the case of the night-time period, the second specific control may be performed, and in the case of the day-time period, the first specific control may be performed. From the same perspective, in step S30, which of the first specific control and the second specific control to execute may be determined based on, for example, weather. Specifically, in the case of rainy weather, the vehicle 10 is made to travel with the wipers operating, so that the electricity consumed by the group of auxiliaries 70 is highly likely to increase. In step S30, therefore, the determination may be performed in such a manner that in the case of rainy weather, the second specific control is performed, and that in the case of fine weather, the first specific control is performed. Thus, what is determined in step S30 can be changed as appropriate. No matter what manner of determination is adopted in step S30, continuing only either the first specific control or the second specific control during a period when the fluctuation condition is met can maintain the direction of electricity supply by the bidirectional converter 50 in the same direction during that period. Thus, burden on the bidirectional converter 50 can be reduced.
The process of step S30 may be omitted. The first specific control may be always performed when the determination in step S10 and the determination in step S20 each yield a YES. Also in this case, continuing the first specific control until the determination in step S70 yields a YES, i.e., throughout a period when the fluctuation condition is met, can maintain the direction of electricity supply by the bidirectional converter 50 in the same direction. From the same perspective, the second specific control may be always performed when the determination in step S10 and the determination in step S20 each yield a YES. In short, only either the first specific control or the second specific control should be continued during a period when the fluctuation condition is met.
The process of step S20 may be omitted. For example, in a case where the capacity of the second battery 40 is relatively small, it is possible to adopt a form in which the first specific control or the second specific control is performed when the determination in step S10 yields a YES, regardless of whether the temperature of the second battery 40 is high or low.
If the process of step S20 is omitted, the temperature sensor 103 may be omitted.
Regarding step S10, the fluctuation condition is not limited to the example in the above-described embodiment. A fluctuation condition of a different substance from the above-described embodiment may be adopted in grasping a state where the fluctuation in the electricity consumed by the group of auxiliaries 70 is large. For example, in connection with fluctuation in the amount of solar radiation, the electricity generated by the solar panel 20 and, by extension, the electricity output by the solar panel 20 can fluctuate within a short time. With this in mind, a condition showing that the fluctuation in the electricity output by the solar panel 20 is large may be adopted as the fluctuation condition. In the case where the fluctuation condition relating to the solar panel 20 is adopted, for example, it is conceivable to set the substance thereof to the effect that a difference between a maximum value and a minimum value of the electricity output by the solar panel 20 during a unit period is equal to or larger than a criterial value that is set beforehand. The fluctuation condition may take both the electricity output by the solar panel 20 and the electricity consumed by the group of auxiliaries 70 into account, or may take only either of them into account. At a minimum, the fluctuation condition should show that the fluctuation in at least either the electricity output by the solar panel 20 or the electricity consumed by the group of auxiliaries 70 is large. In the case where the fluctuation condition has been changed from the example in the above-described embodiment, the ending condition should be changed accordingly.
The contents of each mode of basic control are not limited to the example in the above-described embodiment. At a minimum, the first specific control and the second specific control should be configured so as to be able to maintain the same magnitude relationship between the electricity output by the solar converter 30 and the electricity consumed by the group of auxiliaries 70 regardless of the contents of the basic control.
To restrict the amounts of charge and discharge of the second battery 40 according to the temperature of the second battery 40, it is possible to impose restrictions on the amount of the electricity output by the solar converter 30, etc. when the temperature of the second battery 40 is outside the predetermined range. The basic control, the first specific control, and the second specific control may be performed under such restrictions.
The configuration of each auxiliary 71 is not limited to the example in the above-described embodiment. For example, each auxiliary 71 may be such that the electricity mode can be switched in three or more levels. At a minimum, each auxiliary 71 should be configured to operate by being supplied with the electricity output by the solar converter 30.
Depending on the configuration of the path leading from the solar panel 20 to the solar converter 30, it is possible that alternating-current electricity is input into the solar converter 30. In this case, the solar converter 30 may be configured to convert the alternating current into a direct current and output the direct current. Thus, the solar converter 30 is not limited to one that converts the voltage, and may instead be one that performs AC-DC conversion or one that rectifies the voltage or the current, according to the circuit configuration around the solar converter 30.
The bidirectional converter 50 may be composed of a plurality of converters. This group of converters may realize the functions of performing voltage conversion and switching the direction of electricity supply among the first battery 60, the group of auxiliaries 70, and the solar converter 30.
The overall configuration of the vehicle 10 and, by extension, that of the electricity supply system 10A are not limited to the example in the above-described embodiment. For example, the second battery 40 may be omitted.
The control device 90 may be composed of a plurality of information processing devices that individually controls the devices such as the group of auxiliaries 70, the solar converter 30, and the bidirectional converter 50. Each information processing device is a computer equipped with a processing circuit including a CPU and a memory. Also in the case where the control device 90 is composed of a plurality of information processing devices, if these information processing devices are able to exchange information with one another, the various processes and controls described in the above-described embodiment and the above-described modified examples can be realized.
The configuration of the processing circuit of the control device 90 is not limited to the example in the above-described embodiment. At a minimum, the processing circuit should have the configuration of one of the following (a) to (c):
(a) The processing circuit includes one or more processors that execute various processes according to a computer program. Each processor includes a CPU and a memory such as an RAM and an ROM. The memory stores program codes or commands configured to cause the CPU to execute processes. As the memory, i.e., a computer-readable medium, all available media that can be accessed by a general-or special-purpose computer are included.
(b) The processing circuit includes one or more dedicated hardware circuits that execute various processes. Examples of dedicated hardware circuits include an application-specific integrated circuit, i.e., an ASIC and an FPGA.
(c) The processing circuit includes a processor that executes some of the various processes according to a computer program, and a dedicated hardware circuit that executes the other processes of the various processes.

### Additional Statement

The above-described embodiment and modified examples include the configurations described in the following additional statement.

[Additional Statement 1] An electricity supply system, including: a solar panel; a solar converter that is able to convert electricity output by the solar panel and output the converted electricity; a group of auxiliaries that is supplied with the electricity output by the solar converter; a battery; a bidirectional converter that is able to convert a voltage of electricity output by the battery and supply the converted electricity to the group of auxiliaries, as well as to convert a voltage of the electricity output by the solar converter and supply the converted electricity to the battery; and a control device configured to control the solar converter, the group of auxiliaries, and the bidirectional converter, wherein: the control device executes switching control that, when the electricity output by the solar converter is higher than electricity consumed by the group of auxiliaries, controls the bidirectional converter such that the electricity is directed from the solar converter to the battery, whereas when the electricity output by the solar converter is lower than the electricity consumed by the group of auxiliaries, controls the bidirectional converter such that the electricity is directed from the battery to the group of auxiliaries; and during a period when a fluctuation condition is met that is set beforehand as a condition showing that fluctuation in at least either the electricity output by the solar panel or the electricity consumed by the group of auxiliaries is large, the control device executes specific control that controls one or more selected from the solar converter, the group of auxiliaries, and the bidirectional converter such that a magnitude relationship between the electricity output by the solar converter and the electricity consumed by the group of auxiliaries remains the same.

[Additional Statement 2] The electricity supply system according to [Additional Statement 1], wherein the fluctuation condition is that a difference between a maximum value and a minimum value of the electricity consumed by the group of auxiliaries during a unit period is equal to or larger than a specified value that is set beforehand.

[Additional Statement 3] The electricity supply system according to [Additional Statement 1] or [Additional Statement 2], including, with the battery being a first battery, a second battery to and from which the electricity output by the solar converter is chargeable and dischargeable, and a temperature sensor that detects a temperature of the second battery, wherein the control device executes the specific control based on a requisite condition that the temperature of the second battery is outside a predetermined range that is set beforehand.

[Additional Statement 4] The electricity supply system according to any one of [Additional Statement 1] to [Additional Statement 3], wherein when the electricity output by the solar converter is higher than the electricity consumed by the group of auxiliaries at a timing when a state where the fluctuation condition is not met has switched to a state where the fluctuation condition is met, the bidirectional converter is controlled in the specific control such that the electricity supplied from the bidirectional converter to the battery becomes lower than that in the state where the fluctuation condition is not met.

[Additional Statement 5] The electricity supply system according to any one of [Additional Statement 1] to [Additional Statement 4], wherein when the electricity output by the solar converter is higher than the electricity consumed by the group of auxiliaries at a timing when a state where the fluctuation condition is not met has switched to a state where the fluctuation condition is met, the group of auxiliaries is controlled in the specific control such that the electricity consumed by the group of auxiliaries becomes lower than that in the state where the fluctuation condition is not met.

[Additional Statement 6] The electricity supply system according to any one of [Additional Statement 1] to [Additional Statement 5], wherein when the electricity output by the solar converter is lower than the electricity consumed by the group of auxiliaries at a timing when a state where the fluctuation condition is not met has switched to a state where the fluctuation condition is met, the solar converter is controlled in the specific control such that the electricity output by the solar converter becomes lower than that in the state where the fluctuation condition is not met.

[Additional Statement 7] The electricity supply system according to any one of [Additional Statement 1] to [Additional Statement 6], wherein when the electricity output by the solar converter is lower than the electricity consumed by the group of auxiliaries at a timing when a state where the fluctuation condition is not met has switched to a state where the fluctuation condition is met, the group of auxiliaries is controlled in the specific control such that the electricity consumed by the group of auxiliaries becomes higher than that in the state where the fluctuation condition is not met.

What is claimed is:

1. An electricity supply system, comprising:
a solar panel;
a solar converter that is able to convert electricity output by the solar panel and output the electricity;
a group of auxiliaries that is supplied with the electricity output by the solar converter;
a battery;
a bidirectional converter that is able to convert a voltage of electricity output by the battery and supply the electricity to the group of auxiliaries, as well as to convert a voltage of the electricity output by the solar converter and supply the electricity to the battery; and
a control device configured to control the solar converter, the group of auxiliaries, and the bidirectional converter, wherein:
the control device is configured to execute the following as switching control:
when a first condition is met, controlling the bidirectional converter such that the electricity is directed from the solar converter to the battery; and
when a second condition is met, controlling the bidirectional converter such that the electricity is directed from the battery to the group of auxiliaries;
the first condition is a condition that the electricity output by the solar converter is higher than electricity consumed by the group of auxiliaries;
the second condition is a condition that the electricity output by the solar converter is lower than the electricity consumed by the group of auxiliaries;
the control device is configured to execute specific control during a period when a fluctuation condition is met;
the fluctuation condition is a condition that is set beforehand as a condition showing that fluctuation in at least either the electricity output by the solar panel or the electricity consumed by the group of auxiliaries is large; and
the specific control is control configured to control one or more selected from the solar converter, the group of auxiliaries, and the bidirectional converter such that a magnitude relationship between the electricity output by the solar converter and the electricity consumed by the group of auxiliaries remains the same.

2. The electricity supply system according to claim 1, wherein the fluctuation condition is a condition that a difference between a maximum value and a minimum value of the electricity consumed by the group of auxiliaries during a unit period is equal to or larger than a specified value that is set beforehand.

3. The electricity supply system according to claim 1, further comprising:
a second battery to and from which the electricity output by the solar converter is chargeable and dischargeable; and
a temperature sensor configured to detect a temperature of the second battery, wherein:
the battery is a first battery; and
the control device is configured to execute the specific control based on a requisite condition that the temperature of the second battery is outside a predetermined range that is set beforehand.

4. The electricity supply system according to claim 1, wherein:
the control device is configured to, when the first condition is met at a predetermined timing, control the bidirectional converter in the specific control such that the electricity supplied from the bidirectional converter to the battery becomes lower than that in a state where the fluctuation condition is not met; and
the predetermined timing is a timing when the state where the fluctuation condition is not met has switched to a state where the fluctuation condition is met.

5. The electricity supply system according to claim 1, wherein:
the control device is configured to, when the first condition is met at a predetermined timing, control the group of auxiliaries in the specific control such that the electricity consumed by the group of auxiliaries becomes lower than that in a state where the fluctuation condition is not met; and
the predetermined timing is a timing when the state where the fluctuation condition is not met has switched to a state where the fluctuation condition is met.

6. The electricity supply system according to claim 1, wherein:
the control device is configured to, when the second condition is met at a predetermined timing, control the solar converter in the specific control such that the electricity output by the solar converter becomes lower than that in a state where the fluctuation condition is not met; and
the predetermined timing is a timing when the state where the fluctuation condition is not met has switched to a state where the fluctuation condition is met.

7. The electricity supply system according to claim 1, wherein:
the control device is configured to, when the second condition is met at a predetermined timing, control the group of auxiliaries in the specific control such that the electricity consumed by the group of auxiliaries becomes higher than that in a state where the fluctuation condition is not met; and
the predetermined timing is a timing when the state where the fluctuation condition is not met has switched to a state where the fluctuation condition is met.

8. A control device configured to execute control of a solar converter, a group of auxiliaries, and a bidirectional converter as a processor executes instructions stored in a storage medium, the control device comprising the processor, wherein:
the control device is configured to apply the control to a vehicle;
the vehicle includes the following:
a solar panel;
the solar converter that is able to convert electricity output by the solar panel and output the electricity;
a group of auxiliaries that is supplied with the electricity output by the solar converter;
a battery; and
the bidirectional converter that is able to convert a voltage of electricity output by the battery and supply the electricity to the group of auxiliaries, as well as to convert a voltage of the electricity output by the solar converter and supply the electricity to the battery;
the control device is configured to execute the following as switching control:
when the electricity output by the solar converter is higher than electricity consumed by the group of auxiliaries, controlling the bidirectional converter such that the electricity is directed from the solar converter to the battery; and
when the electricity output by the solar converter is lower than the electricity consumed by the group of auxiliaries, controlling the bidirectional converter such that the electricity is directed from the battery to the group of auxiliaries;
the control device is configured to execute specific control during a period when a fluctuation condition is met;
the fluctuation condition is a condition that is set beforehand as a condition showing that fluctuation in at least either the electricity output by the solar panel or the electricity consumed by the group of auxiliaries is large; and
the specific control is control configured to control one or more selected from the solar converter, the group of auxiliaries, and the bidirectional converter such that a magnitude relationship between the electricity output by the solar converter and the electricity consumed by the group of auxiliaries remains the same.

9. A non-transitory storage medium storing instructions that are executable by one or more processors and that cause the one or more processors of a control device to perform functions comprising:
executing switching control that, when electricity output by a solar converter is higher than electricity consumed by a group of auxiliaries, controls a bidirectional converter such that the electricity is directed from the solar converter to a battery, whereas when the electricity output by the solar converter is lower than the electricity consumed by the group of auxiliaries, controls the bidirectional converter such that the electricity is directed from the battery to the group of auxiliaries; and
executing specific control during a period when a fluctuation condition is met, wherein:
the fluctuation condition is a condition that is set beforehand as a condition showing that fluctuation in at least either electricity output by a solar panel or the electricity consumed by the group of auxiliaries is large;
the specific control is control that controls one or more selected from the solar converter, the group of auxiliaries, and the bidirectional converter such that a magnitude relationship between the electricity output by the solar converter and the electricity consumed by the group of auxiliaries remains the same;
the functions are applied to a vehicle; and
the vehicle includes the following:
the solar panel;
the solar converter that is able to convert the electricity output by the solar panel and output the electricity;
the group of auxiliaries that is supplied with the electricity output by the solar converter;
the battery;
the bidirectional converter that is able to convert a voltage of the electricity output by the battery and supply the electricity to the group of auxiliaries, as well as to convert a voltage of the electricity output by the solar converter and supply the electricity to the battery; and
the control device configured to control the solar converter, the group of auxiliaries, and the bidirectional converter.
